(19) United States
(12) Patent Application Publication
(10) Pub. No.: US 2009/0049243 A1
(43) Pub. Date: Feb. 19, 2009

(54) Caching Dynamic Content

(75) Inventors: Opher Dubrovsky, Redmond, WA (US); Yossi Siles, Tel-Mond (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/837,552

(22) Filed: Aug. 13, 2007

(51) Int. Cl. G06F 12/08

(52) U.S. Cl. 711/118; 711/E12.017

(57) ABSTRACT

Aspects of the subject matter described herein relate to caching dynamic content. In aspects, caching components on a requesting entity and on a content server cache requested content. When a request for content similar to cached content is received, the requesting entity sends a request for the content and an identifier of similar cached content to the content server. The content server obtains the requested content and determines the differences between the requested content and the cached content. The content server then sends the differences to the requesting entity. The requesting entity uses the differences and its cached content to construct the requested content and provides the requested content.

### BACKGROUND

Many companies use hub-and-spoke network arrangements in which satellite offices communicate with a central main office. Communications within a single office may traverse a local area network and be relatively fast while communications between a satellite office and the main office or another satellite office may traverse a relatively slower network. Furthermore, the bandwidth between the main office and the satellite offices may be relatively small and relatively expensive.

### SUMMARY

Briefly, aspects of the subject matter described herein relate to caching dynamic content. In aspects, caching components on a requesting entity and on a content server cache requested content. When a request for content similar to cached content is received, the requesting entity sends a request for the content and an identifier of similar cached content to the content server. The content server obtains the requested content and determines the differences between the requested content and the cached content. The content server then sends the differences to the requesting entity. The requesting entity uses the differences and its cached content to construct the requested content and provides the requested content.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram representing a content server configured to provide content in accordance with aspects of the subject matter described herein;

FIG. 4 is a block diagram representing a content requester configured to request content in accordance with aspects of the subject matter described herein; and

FIGS. 5-8 are flow diagrams that generally represent exemplary actions that may occur in obtaining content in accordance with aspects of the subject matter described herein.

### DETAILED DESCRIPTION

### Exemplary Operating Environment

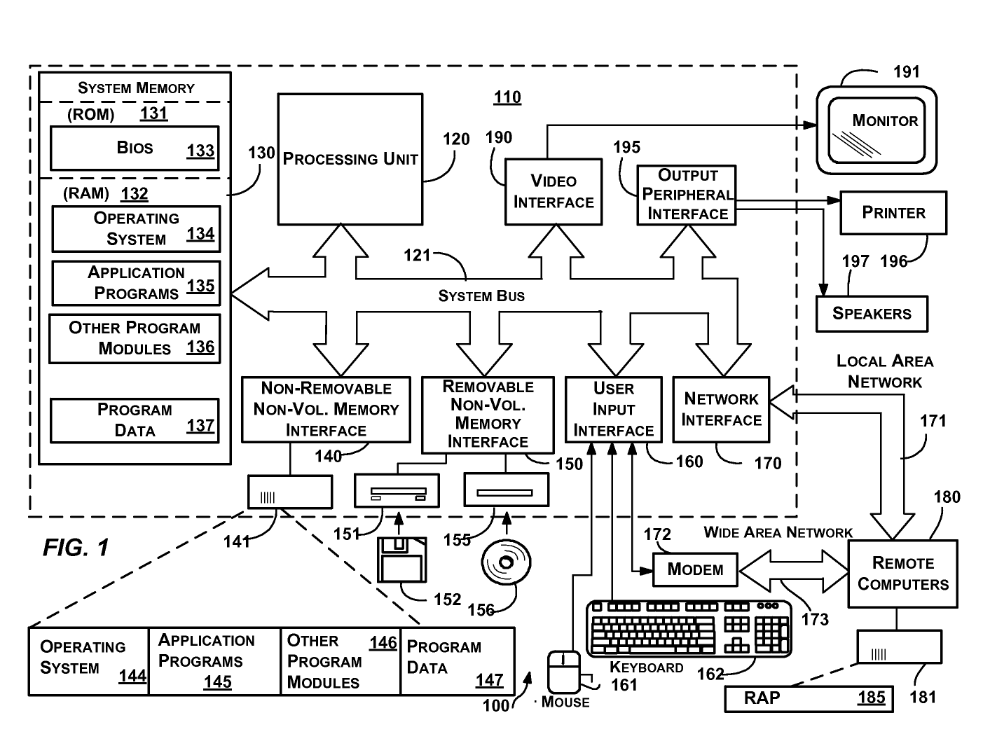

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Caching and Transmitting Data

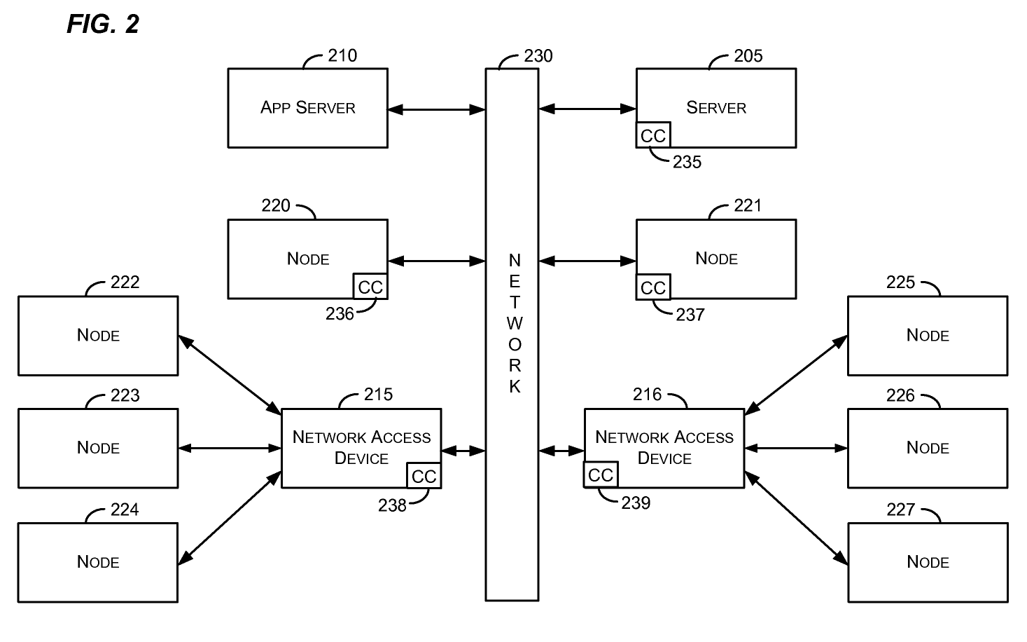

As mentioned previously, companies that have nodes in various satellite offices may have network links that are relatively slow and have relatively small bandwidth. FIG. 2 is a block diagram representing an exemplary environment in which aspects of the subject matter described herein may be implemented. The environment includes a server 205, an application server 210, network access devices 215-216, nodes 220-227, and a network 230 and may include other entities (not shown). The various entities may communicate with each other via various networks including intra- and inter-office networks and the network 230. In an embodiment, the network 230 may comprise the Internet. In an embodiment, the network 230 may comprise one or more private networks, virtual private networks, and the like.

The server 205, nodes 220-221, and network access devices 215-216 may include cache components 235-239 which cache content received by the entities as described in more detail below.

Each of the server 205 and the nodes 220-227 may be implemented on or as one or more computers (e.g., the computer 110 as described in conjunction with FIG. 1). The nodes 222-224 and the network access device 215 may comprise nodes at one branch office while the nodes 225-227 and the network access device 216 may comprise nodes at another branch office. The nodes 220 and 221 may represent users who are traveling, small branch offices, and the like. The server 205 may be located at company headquarters or at another location. The app server 210 may also be located at company headquarters or at another location.

Note that the terms “main office” and “branch office” are used for illustrative purposes. There is no intention to limit aspects of the subject matter described herein to companies with main offices and branch offices. Nor is there any intention to limit aspects of the subject matter described herein to hub-and-spoke type arrangements or to low bandwidth or high latency networks. Indeed, it will be recognized by those skilled in the art that aspects of the subject matter may be employed between any two entities connected by any type of network.

The network 230 (or at least the links from the entities to the network 230) may be a relatively slow and bandwidth limited network, although aspects of the subject matter described herein may also be applied to high speed and high bandwidth networks. When the network 230 is relatively slow and/or bandwidth limited, it may be more advantageous to minimize the traffic that crosses the network 230. In particular, if a node is able to obtain a cached copy of content without going over the network 230, greatly improved performance may result.

Dynamic web pages have posed a problem in caching content as by very definition, this type of content is dynamic and may change from request to request. In the past, dynamic web pages have not been cached or, if cached, have not been effective in increasing performance.

In accordance with aspects of the subject matter described herein, caching components on various nodes may cache content including dynamic and static web pages and then use the cached content to improve performance.

In particular, a node that is requesting content (hereinafter sometimes referred to as a “requesting node”) may request dynamic content (e.g., dynamic page A). In response, a caching component (sometimes referred to as a requesting cache) associated with a requesting node may send the request to a node that provides the content (hereinafter sometimes referred to as a “server node”). The server node may generate the content, have it cached, and send it back to the requesting cache, which may then cache the content and send it back to the requesting node.

Another or the same requesting node may request additional dynamic content (e.g., dynamic web page A′). The requesting cache may check its cache to determine that it has similar dynamic content already cached (e.g., dynamic web page A). The requesting cache may send a request for the additional dynamic content together with an identifier of the already cached dynamic content to a server node. The server node may then create the dynamic content, calculate the difference between the first dynamic content and the second dynamic content, and send a differences data structure back to the requesting cache. The requesting cache may use the cached first dynamic content together with the differences data structure to construct the second dynamic content. The requesting cache can then send the second dynamic content to the requesting node.

A differencing data structure may comprise a file, markup language such as XML, HTML, and so forth, a list of differences, and the like.

As a further improvement, the server node may attempt to further compress the differencing data structure using one or more compression algorithms before sending the differences data structure to the requesting node. The compression algorithms may be applied during or after the creation of the differencing data structure.

As another optimization, the server node may determine whether it is faster to send the differences or the entire second dynamic content. If it is faster to send the entire second dynamic content, it may be sent instead of the differences. For example, if a list of differences is actually greater in size than the second dynamic content, the second dynamic content may be sent instead of the differences.

Whether dynamic content is similar to what has been requested before may be determined via a URL, cookie, or some other mechanism. For example, dynamic content indicated by the URL of http://www.spaces.com/weather?Parameter1=ZipCodeY may be determined similar to dynamic content indicated by the URL of http://www.spaces.com/weather?Parameter1=ZipCodeX. In one embodiment, this similarity may be determined by examining the URL up to where the parameter starts (e.g., the “?”).

In one embodiment, an identifier for dynamic content may be calculated by performing a hash on the URL, content, portion thereof, or otherwise. In another embodiment, an identifier may be assigned by the requesting cache, the server node, or another component and may be communicated with requests or responses for content.

In one embodiment, the application server 210 may reside on a network that is local to the server 205. In another embodiment, the application server 210 may reside on a network external to the local network upon which the server 205 resides.

The network access devices 215 and 216 may comprise computers (e.g., such as the computer 110 as described in conjunction with FIG. 1) and may be general or special purpose devices. In one embodiment, the network access devices 215 and 216 may comprise proxy servers. A proxy server is a device and/or software that attempts to obtain content from the fastest or nearest source. The network access devices 215 and 216 may cache content to aid in quick retrieval of the content as well as in creating similar content from a differences file.

The caching components 236 and 237 on the nodes 220 and 221, respectively, may be configured such that they intercept or are otherwise able to examine and act on communications with the network 230. For example, the caching components may reside in or be called from a networking stack that receives requests from the node for content external to the node. In this configuration, the caching component may examine each request and forward, receive responses, construct pages, cache responses, and so forth as described previously.

Although the environment described above includes a server, an application server, two network access devices, and nodes in various configurations, it will be recognized that more, fewer, or a different combination of these and other entities may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

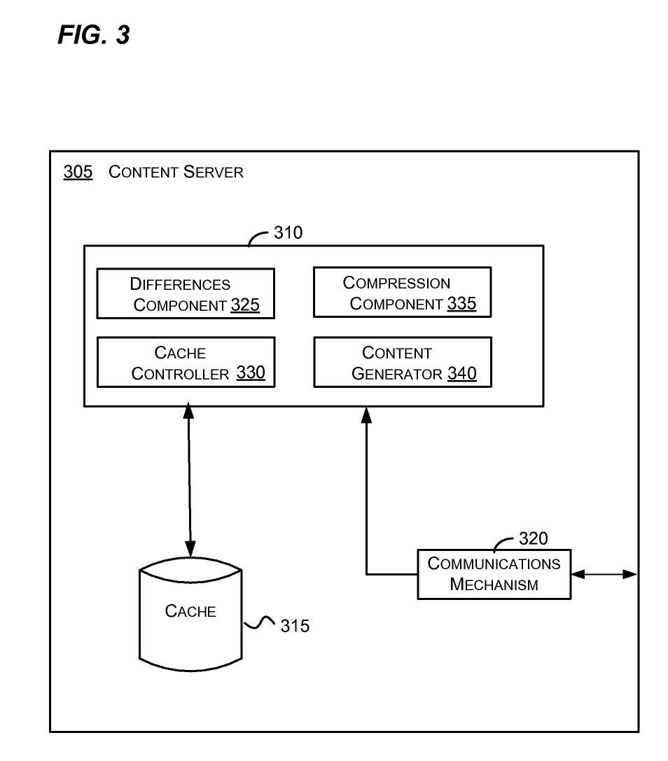

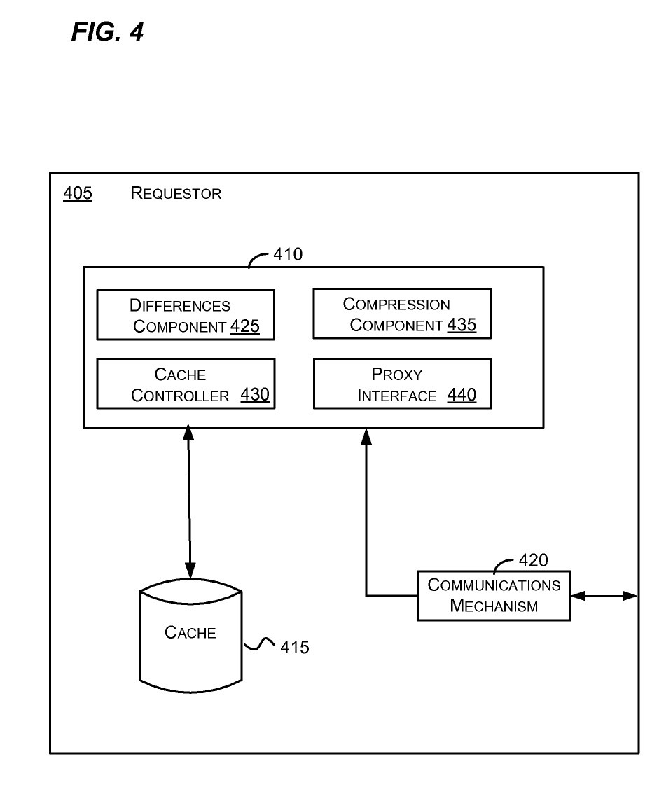

FIGS. 3 and 4 are block diagrams that include various components in accordance with aspects of the subject matter described herein. The components illustrated in FIGS. 3 and 4 are exemplary and are not meant to be all-inclusive of components that may be needed or included. In other embodiments, the components or functions described in conjunction with FIGS. 3 and 4 may be included in other components or placed in subcomponents without departing from the spirit or scope of aspects of the subject matter described herein.

FIG. 3 is a block diagram representing a content server configured to provide content in accordance with aspects of the subject matter described herein. The content server 305 may include caching components 310, a cache 315, and a communications mechanism 320. The caching components 310 correspond to the caching component 235 of FIG. 2 and may include a differences component 325, a cache controller 330, a compression component 335, a content generator 340, and other components (now shown).

The cache 315 comprises any storage media capable of storing content. The term content should be read to include information, program code, program state, program data, other data, and the like. The cache 315 may comprise a file system, database, volatile memory such as RAM, other storage, some combination of the above, and the like and may be distributed across multiple devices. The cache 315 may be external or internal to the content server 305.

The communications mechanism 320 allows the content server 305 to communicate with nodes that seek to access content available from the content server 305 as well as nodes that provide content to the content server 305. The communications mechanism 320 may be a network interface or adapter 170, modem 172, or any other mechanism for establishing communications as described in conjunction with FIG. 1.

The differences component 325 has logic for calculating the differences between two pieces of content. The differences component 325 may calculate these differences and use a variety of mechanisms for representing these differences as will be understood by those skilled in the art without departing from the spirit or scope of aspects of the subject matter described herein. The differences component 325 may output differences between two pieces of content into a differences data structure.

The compression component 335 may take a first data structure or stream as input and provide a second data structure or stream that is compressed as output. For example, the compression component 335 may receive a differences data structure and may produce a compressed differences data structure. As will be understood by those skilled in the art, there are many compression algorithms that may be used by the compression component 335 to compress data. The selection of which compression algorithm to use may depend on the anticipated domain of data to be compressed. After a data structure is compressed, the compressed data structure may then be sent to a requester via the communications mechanism 320.

In one embodiment, the compression component 335 may be included in the differences component 325 such that the differences component 325 attempts to compress the output as it creates the differences. In another embodiment, the compression component 335 may be separate from the compression component 335.

The cache controller 330 may maintain and access the cache 315. Among its functions, the cache controller 330 may determine how to update, replace, and expire cache entries as well as search the cache for entries indicated by an identifier. The cache controller 330 may include a hashing function that hashes the content, an identifier of the content, or a portion of either the content or the identifier to form an index to the cache 315. In an embodiment, only a singled copy of similar dynamic content is cached in the cache 315. Thus, if content is requested including A, A′, and A″, where A, A′, and A″ are similar dynamic content, only one of the content is cached by the cache controller 330.

In another embodiment, the cache controller 330 may cache multiple variations of dynamic content. If it is anticipated that requesters (perhaps from different branches) may request identical dynamic content, this caching of variations may eliminate the need to request content from an application server, for example. A variation entry may be expired if they have not been accessed in a configurable amount of time.

In one embodiment, a variation may be replicated to caches in various branch offices, such that a branch cache will not have to make requests from a server at the main office if a requested variation was replicated and is already cached locally. To avoid some impact on the bandwidth usage caused by the replication, the server at the main office may replicate variation versions only to branches which requested the specified variations within a certain preceding timeframe.

The content generator 340 may receive a request for content and may send one or more requests to other entities to obtain portions of the content. After obtaining the portions of the content, the content generator 340 may assemble the content into a data structure formatted (e.g., HTML, XML, etc.) according to the requestor's request. In an embodiment, the content generator 340 may generate the content or a portion thereof based on data included on the content server 305 with or without obtaining content from other sources.

FIG. 4 is a block diagram representing a content requester configured to request content in accordance with aspects of the subject matter described herein. The content requester 405 may correspond to the network access devices 215-216 and/or the nodes 220-221 of FIG. 2. The content requester 405 may include caching components 410, a cache 415, and a communications mechanism 420. The caching components 410 correspond to the caching components 236-239 that may be found on each of the nodes 220-221 and the network access devices 215-216 and may include a differences component 425, a cache controller 430, a compression component 435, a proxy interface 440, and other components (not shown).

The cache 415 comprises any storage media capable of storing content. The cache 415 may comprise a file system, database, volatile memory such as RAM, other storage, some combination of the above, and the like and may be distributed across multiple devices. The cache 415 may be external or internal to the requester 405.

The communications mechanism 420 allows the requester 405 to request content and to provide identifiers associated with currently cached content. The communications mechanism 420 may be a network interface or adapter 170, modem 172, or any other mechanism for establishing communications as described in conjunction with FIG. 1.

The differences component 425 has logic for creating content from a differences data structure and content. As described previously, this allows the differences component 425 to construct requested content from existing cached content and a differences data structure.

The cache controller 430 may maintain and access the cache 415. Among its functions, the cache controller 430 may determine how to update, replace, and expire cache entries as well as search the cache for entries indicated by an identifier. The cache controller 430 may include a hashing function that hashes the content, an identifier of the content, or a portion of either the content or the identifier to form an index to the cache 415.

The compression component 435 may take a first data structure or stream as input and provide a second data structure or stream that is uncompressed as output. For example, the compression component 435 may receive a differences data structure and may produce an uncompressed differences data structure. After a data structure is uncompressed, the uncompressed data structure may then be sent to the differences component 425 to create content as described previously.

In one embodiment, the compression component 335 may be included in the differences component 325. In another embodiment, the compression component 335 may be separate from the compression component 335.

The proxy interface 440 may operate to receive requests for content from a node, application, or otherwise and to respond to the requests as appropriate. The proxy interface 440 may be structured to be seamless to the requester of the content. In other words, a requesting entity may not need to be modified to work with the proxy interface 440.

In one embodiment, the proxy interface 440 may comprise a component that resides in a network stack. This may be more advantageous for a requester that does not use a proxy network access device to request content. For example, this may be preferred in the nodes 220 and 221. Because it resides in the network stack, the proxy interface 440 may determine when a request is for content that the caching components 410 can expedite.

In another embodiment, the proxy interface 440 may comprise a component that receives and responds to requests from other nodes. For example, referring to FIG. 2, the proxy interface 440 may be a component on the network access devices 215 and 216 that receives requests for content from the nodes 222-227 and responds to those requests as appropriate.

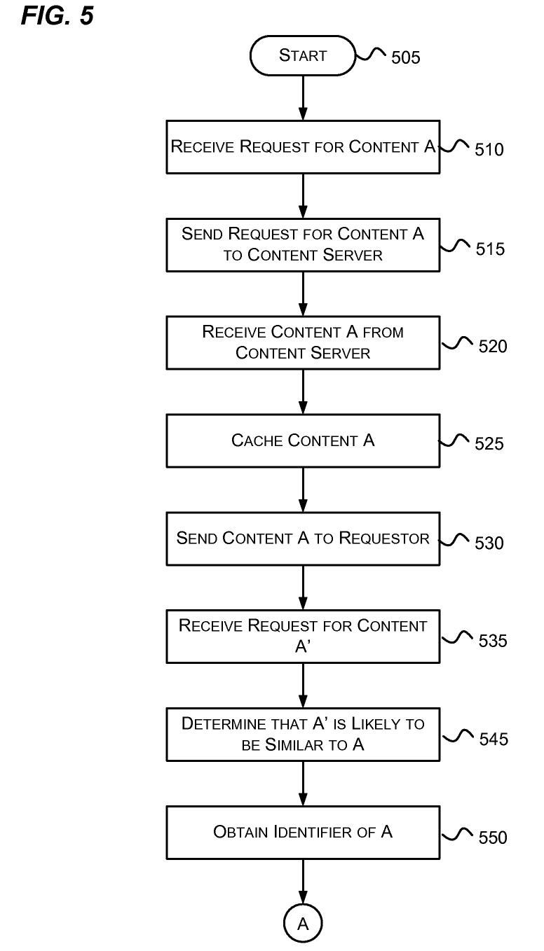

FIGS. 5-8 are flow diagrams that generally represent exemplary actions that may occur in obtaining content in accordance with aspects of the subject matter described herein. For simplicity of explanation, the methodology described in conjunction with FIGS. 5-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. At block 510, a request for content is received. For example, referring to FIG. 2, the caching components 238 may receive a request for content (e.g., A) from the node 222.

At block 515, the request for the content is sent to a content server. Before the request is sent to the content server, a check may be performed to determine whether the content is cached locally. If so, the content may simply be returned without requesting it from the content server. In addition, a check may be made as to whether the request is for similar content. If so, the actions may continue at block 550. In the example shown in FIG. 5, for simplicity, it is assumed that neither the content nor any similar content has been requested before, or, if it has, that neither the content nor the similar content are still cached.

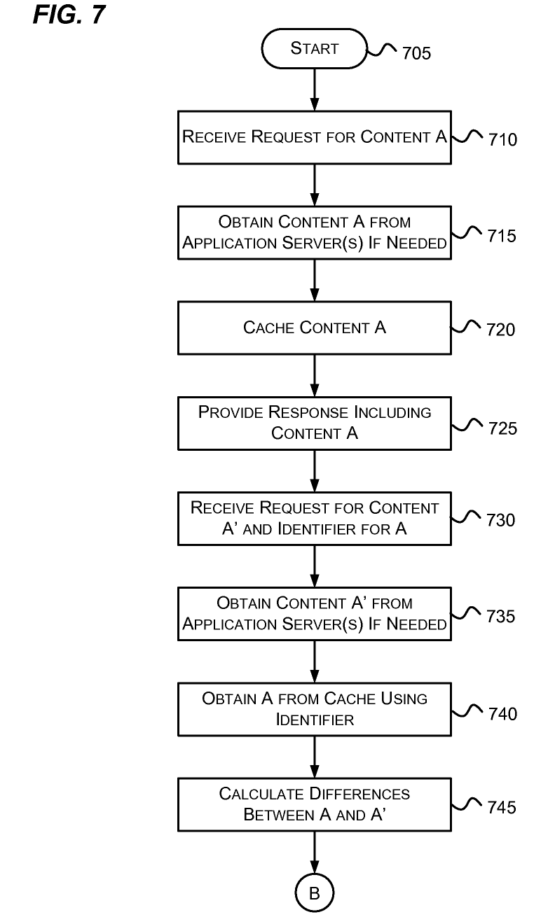

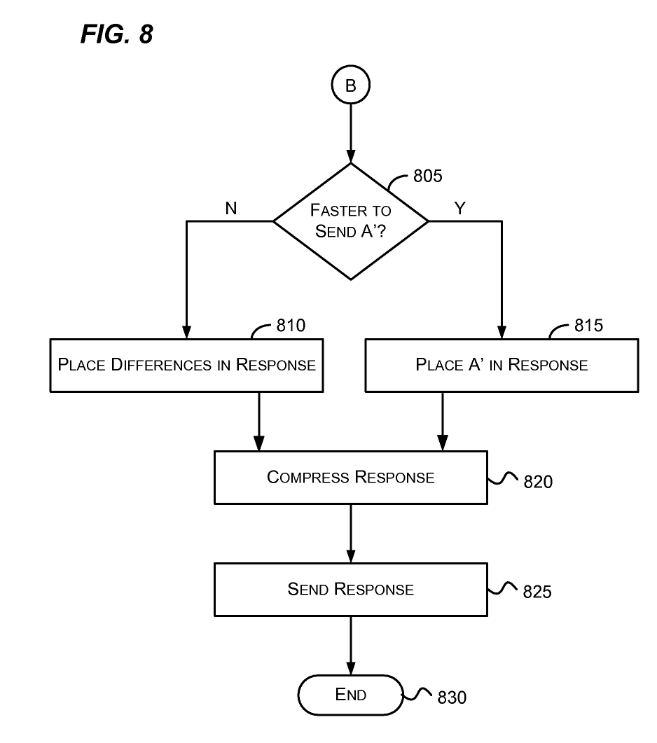

At block 520, the content is received from the content server. For example, referring to FIG. 2, the caching components 238 receive the content from the server 205. Note that the actions the server may take are described in more detail in conjunction with FIGS. 7 and 8.

At block 525, the content is cached. For example, referring to FIG. 2, the caching components 238 cache the content in a local cache.

At block 530, the content is sent to the requesting entity. For example, referring to FIG. 2, the caching components 238 send the content to the node 222.

At block 535, a request for similar content (e.g., A′) is received. Referring to FIG. 2, this may received from the same node (e.g., node 222) or from a different node (e.g., node 223 or 224).

At block 545, a determination is made that the content is likely to be similar to cached content. This may be done via examining the URL, cookie, or other data associated with the request and comparing this with cached identifiers. For example, referring to FIG. 4, the cache controller 430 is instructed to search for a cache entry for a URL starting with http://www.spaces.com/weather. The cache controller 430 may find such an entry and indicate success or may not find such an entry and may indicate failure. If the entry is not found, the actions may continue at block 515. Otherwise, the actions may continue at block 545.

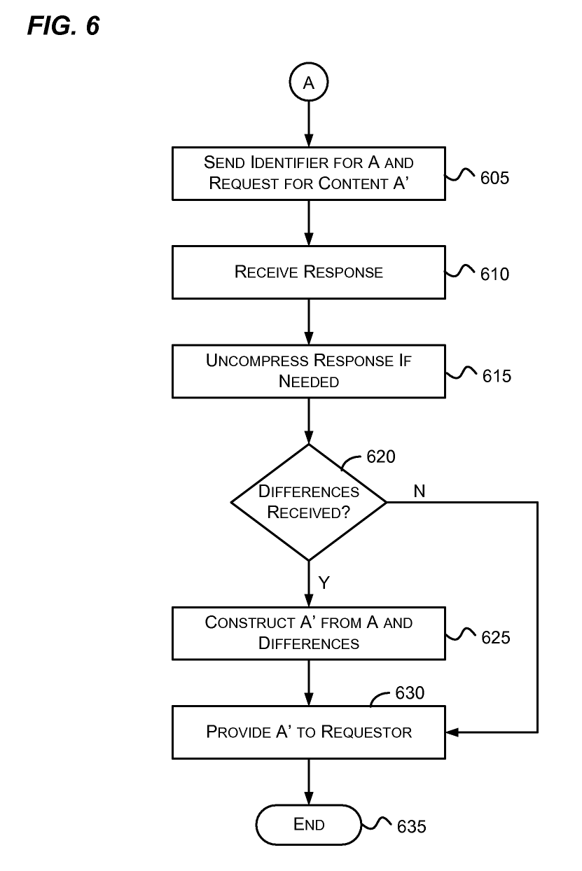

At block 555, an identifier of the cached content is obtained. For example, referring to FIG. 4, the cache controller 430 may return the identifier of the found entry to the proxy interface 440. After block 550, the actions continue at block 605 of FIG. 6.

Turning to FIG. 6, at block 605, the identifier and the request for content are sent to the content server. For example, referring to FIG. 2, the caching components 238 of the network access device 215 send the request for content and the identifier of cached content to the server 205.

At block 610, a response including the requested content is received. For example, referring to FIG. 2, the caching components 238 receive a response from the server 205. Note that exemplary actions the server may take are described in more detail in conjunction with FIGS. 7 and 8.

At block 615, the response is uncompressed if needed. If the server sends the response in compressed format (which may happen some or all of the time), the response may be uncompressed at block 615. For example, referring to FIG. 4, the compression component 435 uncompresses the response.

At block 620 a determination is made as to whether differences were received. If so, the actions continue at block 625; otherwise, the actions continue at block 630. Recall that the server may determine that it is faster to send the actual requested content rather than the differences.

At block 625, the requested content is constructed using the differences and the cached content. For example, referring to FIG. 4, the differences component 425 may take as input a differences data structure and cached content and may provide as output the requested content.

At block 630, the requested content is provided to the requester. For example, referring to FIG. 2, the caching components 238 provide the requested content to the requesting node (e.g., one of 222-224).

At block 635, the actions end.

Turning to FIG. 7, at block 705, the actions begin. At block 710, a request for content is received at a content server. For example, referring to FIG. 2, the server 205 receives a request for content from the caching components 238 of the network access devices 215.

At block 715, the server obtains the content from one or more applications servers if needed. For example, referring to FIG. 2, the server 205 may obtain content from the application server 210. It is possible that the server may be able to generate the content without the assistance of application servers. If so, the server may generate the content without consulting an application server.

Furthermore, although not shown, it is also possible that the server may have cached content that is suitable for the request and may have received the request in conjunction with an identifier of content cached by the requester. If so, the actions may continue at block 745.

At block 720, the content is cached. For example, referring to FIG. 3, the cache controller 330 caches the content in the cache 315.

At block 725, a response is provided that includes the content. For example, referring to FIG. 2, the server 205 provides a response that includes the content to the caching components 238.

At block 730, a request for content and an identifier of content cached by a requester is received. For example, referring to FIG. 2, the caching components 238 send a request to the server 205 and include an identifier of content cached by the caching components 238.

At block 735, the content is obtained similarly to the actions described in conjunction with bock 715.

At block 740, the identifier is used to obtain content cached at the server. For example, referring to FIG. 3, the cache controller 330 retrieves content from the cache 315 using the identifier passed to the content server 305.

At block 745, differences between the cached content and the requested content are calculated. For example, referring to FIG. 3, the differences component takes as input the cached content and the requested content and produces as output a differences data structure that indicates differences between the cached content and the requested content. After block 745, the actions continue at block 805 of FIG. 8.

Turning to FIG. 8, at block 805, a determination is made as to whether it is faster to send the requested content or the differences data structure. If so the actions continue at block 815; otherwise, the actions continue at block 810.

At block 810, the differences are placed in the response. At block 815, the requested content is placed in the response.

At block 820, the response is compressed. For example, referring to FIG. 3, the compression component 335 compresses the response.

At block 825, the response is sent to the requester. For example, referring to FIG. 2, the server 205 sends the response to the caching components 238.

At block 830, the actions end.

As can be seen from the foregoing detailed description, aspects have been described related to caching dynamic content. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
receiving a first request for a requested content;
determining that a cached content is likely to be similar to the requested content;
sending an identifier of the cached content and a second request for the requested content; and
receiving a response that includes or is usable to create the requested content.

2. The computer-readable medium of claim 1, wherein determining that the cached content is likely to be similar to the requested content comprises examining a resource identifier included in the first request and comparing the resource identifier to one or more identifiers associated with the cached content.

3. The computer-readable medium of claim 2, wherein the resource identifier comprises a uniform resource locator suitable for identifying content on the Internet.

4. The computer-readable medium of claim 2, wherein comparing the resource identifier comprises comparing a portion of the resource identifier to the one or more identifiers identifying the cached content.

5. The computer-readable medium of claim 1, wherein determining that a cached content is likely to be similar to the requested content comprises examining data passed in or with the first request, the data having been first received in response to a previous request.

6. The computer-readable medium of claim 5, wherein a requester providing the first request is not supposed to change the data.

7. The computer-readable medium of claim 1, further comprising creating the identifier by performing a hash on at least some of the cached content.

8. The computer-readable medium of claim 1, wherein the identifier is created by performing a hash on an identifier of the cached content.

9. The computer-readable medium of claim 1, wherein the response comprises differences between the cached content and the requested content.

10. The computer-readable medium of claim 9, further comprising uncompressing the response.

11. A method implemented at least in part by a computer, the method comprising:
receiving a request for requested content and an identifier of cached content;
generating the requested content;
retrieving the cached content using the identifier;
creating differences data between the requested content and the cached content; and
sending a response to the request.

12. The method of claim 11, wherein the response includes the differences data if the differences data is smaller than the requested content.

13. The method of claim 11, wherein the response includes the requested data if the difference data is larger than the requested content.

14. The method of claim 11, further comprising compressing the differences data for sending in the response.

15. The method of claim 11, wherein the requested content comprises content that is more likely different for each request.

16. The method of claim 11, further comprising caching each dynamic content for each request until a time has elasped.

17. The method of claim 16, further comprising replicating the response to a plurality of content requesters.

18. In a computing environment, an apparatus, comprising:
a communications mechanism operable to receive a request for requested content from a requester external to the apparatus, the request including an identifier that identifies content cached on the requester;
a cache operable to store the requested content;
a content generator operable to obtain the requested content; and
a differences component operable to determine differences between cached content and the requested content and to generate a differences data structure indicating the differences.

19. The apparatus of claim 18, further comprising logic that indicates whether to send the requested content or the differences data structure.

20. The apparatus of claim 18, further comprising a compression component operable to compress the differences data structure prior to transmission to the requester.
